(19) United States
(12) Patent Application Publication
(10) Pub. No.: US 2004/0134885 A1
(43) Pub. Date: Jul. 15, 2004

(54) Etching and cleaning of semiconductors using supercritical carbon dioxide

(76) Inventors: Subramanyam A. Iyer, Santa Clara, CA (US); Vijayakumar S. Ramachandrarao, Hillsboro, OR (US); Robert B. Turkot JR., Hillsboro, OR (US)

Correspondence Address: Timothy N. Trop, TROP, PRUNER & HU, P.C., 8554 KATY FWY, STE 100, HOUSTON, TX, 77024-1841, US

(21) Appl. No.: 10/342,053

(22) Filed: Jan. 14, 2003

(51) Int. Cl. B44C 1/22

(52) U.S. Cl. 216/83

(57) ABSTRACT

Liquid phase co-solvent(s) may be combined with supercritical carbon dioxide for more effective use of wet chemistries for cleaning and etching applications in semiconductor fabrication technologies. Because of the use of the two-phase system, more effective solvents, for example that may not be completely soluble in supercritical carbon dioxide, may be utilized, and the benefits of both the supercritical carbon dioxide gas-like phase and the liquid co-solvent may be achieved, in some cases. The efficacy of supercritical carbon dioxide cleaning can be enhanced by repetition of the etch/clean steps on the substrate, sometimes in conjunction with intervening rinse steps.

### BACKGROUND

This invention relates generally to the fabrication of integrated circuits.

During the fabrication of integrated circuits it is necessary to remove undesired residues or to form structures. Commonly, the term “etching” is used to refer to the use of chemistry to form desired features on a semiconductor structure and the word “clean” is used to refer to the removal of undesired materials, such as residues.

In many cases, the removal of materials using wet chemistry may be difficult. In connection with cleaning operations, the complete dissolution of some residues and/or antireflective coating (ARC) is difficult because the residue may have a hard coating that makes it difficult for most wet chemistries to penetrate. The presence of chemically delicate materials on the semiconductor substrate may preclude the use of aggressive chemicals or approaches (such as plasma) for etching or cleaning. In particular, in many cases there is not a complete dissolution of the residue (and/or the ARC) during the clean and any subsequent rinse steps. As a result, contaminants may be undesirably left behind on the semiconductor substrate, adversely affecting the functionality of the integrated circuit.

Thus, there is a need for better ways to complete wet etch and cleaning operations.

### BRIEF DESCRIPTION OF THE DRAWINGS

FIG. 1 is a schematic depiction of one embodiment of the present invention;

FIG. 2 is an enlarged, schematic, cross-sectional view of a portion of the embodiment shown in FIG. 1 in accordance with one embodiment of the present invention;

FIG. 3 is a schematic depiction of another embodiment of the present invention;

FIG. 4 is a schematic depiction of another embodiment of the present invention;

FIG. 5 is a schematic depiction of another embodiment of the present invention;

FIG. 6 is a schematic depiction of a cleaning step according to one embodiment of the present invention; and

FIG. 7 is a schematic depiction of a rinse step according to another embodiment of the present invention.

### DETAILED DESCRIPTION

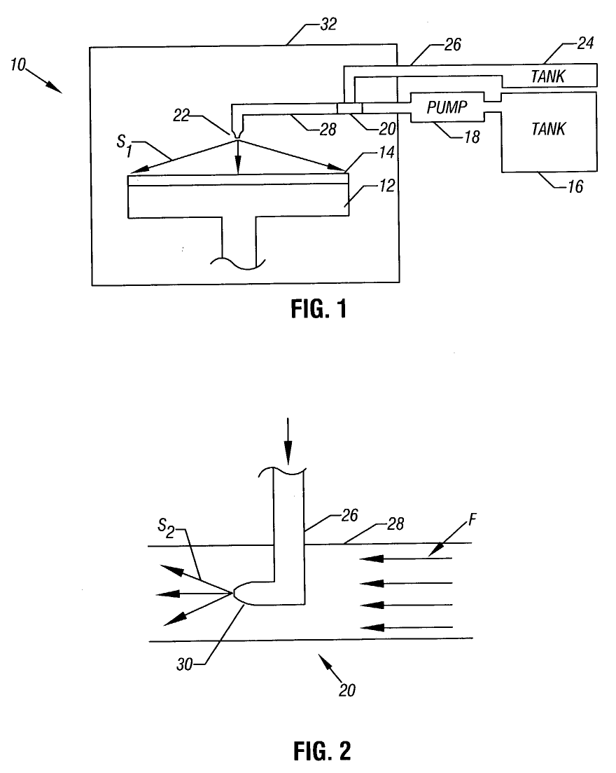

Referring to FIG. 1, a system 10 may include a platen 12 that supports a semiconductor substrate (such as a wafer) 14 inside a pressure vessel 32. The substrate 14 may be exposed to a flow of fluid, indicated as S1, issuing from a nozzle 22. The nozzle 22 may be supplied by a line 28, coupled to a pump 18 and a tank 16. In one embodiment of the present invention, the tank 16 may supply a flow of supercritical carbon dioxide.

The tank 24 may provide a co-solvent, which is supplied through the line 26. Thus, referring to FIG. 2, in one embodiment of the present invention, the line 28 may have a flow, indicated as F, of supercritical carbon dioxide. The line 26 may provide an injection of liquid solvent into the flow F in one embodiment. The injection of the solvent from the nozzle 30 is indicated by the arrows S2.

As a result, a two-phase mixture of co-solvent and supercritical carbon dioxide may be provided. The substrate may then be exposed to this two-phase mixture, as indicated at S1, over the substrate. In one embodiment, the mixture may be sprayed in the form of liquid droplets over the substrate 14. However, any other dispersion technique may also be used.

Supercritical carbon dioxide has gas-like diffusivity and viscosity and liquid-like density, while being chemically almost inert. Supercritical carbon dioxide can not dissolve common plasma etch residues and long polymer chains comprising the photoresist. Hence, a host of chemically reactive agents have to be used in conjunction during supercritical carbon dioxide-based cleans. Carbon dioxide becomes supercritical at temperatures above 30° C. and pressures above 1000 pounds per square inch.

The solvent provided in the tank 24 may be selected, not based on its solubility in supercritical carbon dioxide alone, but rather on its ability to dissolve the residue or other material on the substrate in one embodiment. In other words, because a two-phase system is provided to begin with, it is not necessary that the co-solvent be miscible in the supercritical carbon dioxide. Instead, the selection of the co-solvent may be optimized for the cleaning or etching task at hand.

In addition, the amount of the co-solvent may exceed the amount of co-solvent that can be taken into solution in the supercritical carbon dioxide (i.e. solubility limit), thereby coercing the system to be a two-phase system. Moreover, using additional co-solvents, in some embodiments, may improve the cleaning/etching capability of the mixture.

If residue or photoresist to be removed is soluble in the solvent, which is in a second phase, usually a liquid phase, the solute-laden co-solvent is still a single phase that can be much easier to remove in fewer rinse cycles, ensuring complete removal of the residue. Hence, the mechanism of removal includes both the chemical interaction between the co-solvent and the solute and the physical removal of the mixture as opposed to relying on only physical means to lift off the residue when the co-solvent exists as a single phase in the solution of supercritical carbon dioxide with the residue being unable to go into the same phase. In some embodiments, the formation of the two-phase system of supercritical carbon dioxide and co-solvent can involve the formation of a suspension of liquid in supercritical carbon dioxide, such as the formation of an aerosol of co-solvent in the supercritical carbon dioxide, or other techniques. Also, the use of minute amounts of very strong chemical reagents dissolved (one-phase)/suspended (two-phase) in supercritical carbon dioxide with very short contact times is extremely advantageous as opposed to using these chemicals in the liquid form by themselves or other liquid diluents. In general, the supercritical carbon dioxide is one phase and the co-solvent(s) form another phase(s) which may include liquid droplets of co-solvent(s) of any desired droplet size.

For embodiments in which it is desired to remove residues, such as residues that may contain polymers, antireflective coatings, and/or photoresist, long chain hydrocarbons with similar reactive groups that have poor solubility in supercritical carbon dioxide may be utilized as the co-solvent. In general, chemistries that are effective in dissolving photoresist and antireflective coatings may be used regardless of their solubility in supercritical carbon dioxide.

Examples of suitable co-solvents include sulfolane, together with aqueous and/or organic hydroxide mixtures; organic solvents, such as dimethyl acetamide, together with organic and hydrogen peroxides; or organic acids, such as acetic acid, together with organic solvents and fluoride ion sources, glycol ethers, alkylene glycols to name a few.

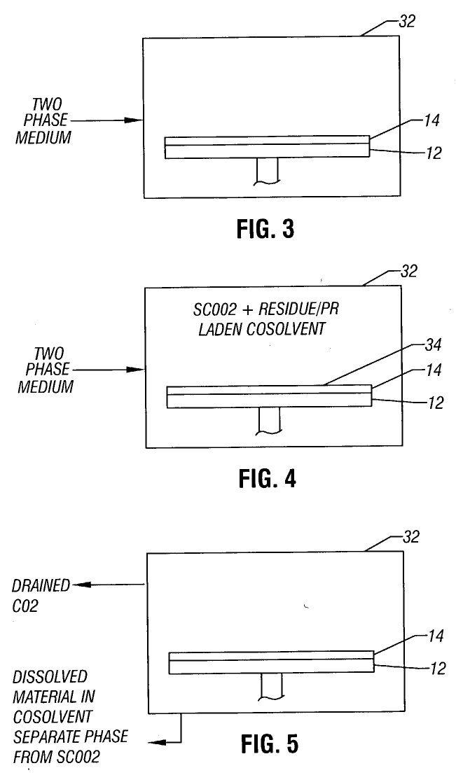

Thus, referring to FIG. 3, a chamber 32 may receive a two-phase medium of co-solvent and supercritical carbon dioxide for example, using the apparatus shown in FIGS. 1 and 2. As a result of the interaction of the two-phase medium with residues on the substrate 14, the two-phase mixture of supercritical carbon dioxide (SCCO2), with the applied co-solvent and the dissolved residue, is formed in the chamber 32 as indicated in FIG. 4.

Also, at the same time, a saturated single phase, that may include supercritical carbon dioxide, co-solvent, and some residue solution, may exist at the surface 34 of the substrate and some left over residue may still be existent on the substrate. In other words, a liquid phase may exist on the surface 34 while a gas-like suspension is still entrained in the atmosphere within the chamber 32.

Rinses are often required during supercritical carbon dioxide-based cleans for the effective removal of the co-solvents themselves and physically dislodging the remaining residues.

One or more rinses of supercritical carbon dioxide, together with the same or different solvents, may continue to be applied repeatedly until the residues have been removed.

Next, as shown in FIG. 5, the substrate 14 is now clean. The supercritical carbon dioxide may be drained from the chamber 32, either in the form of a liquid or a gas-like phase. The dissolved material may also be drained as a separate liquid phase from the supercritical carbon dioxide. Generally, the dissolved residue, that may include photoresist or other materials to be removed, may be entrained in the co-solvent in a liquid phase and simply drained from the chamber 32.

Thus, in some embodiments, the amount of contamination may be reduced. A greater likelihood of removal of the residue may be achieved in some cases. The enhanced integrity of the cleans technology and the reduction of the number of process rinses may be additional advantages with some embodiments. In some embodiments it may not be necessary to physically remove the residue. Instead, the action of the chemistry may be sufficient. In other embodiments, the supercritical carbon dioxide may be flowed across the substrate.

In using any cleaning or etching chemistry, it may be desirable to cycle through a number of cleaning/etching steps each of which may/may not be followed by rinsing steps. The repetitive nature of these steps may have beneficial effects, especially when the cleaning/etching and/or rinsing steps are varied during subsequent iterations.

For example, in one embodiment of the present invention, a first rinse following a cleaning/etching step may include the use of alcohol-water mixtures or other organic solvents, with or without surfactants, tailored to physically dislodge or loosen the material sought to be removed and to sweep it away or to increase its etchability in a subsequent cleaning or etching step. The subsequent cleaning or etching step(s) can be of the same or more dilute strength than the first cleaning or etching step or may be a completely different chemistry. The second rinse step may then be the same or different from the first rinse step, depending on whether any of the material to be removed remains to be loosened or swept away or only process chemicals have to be removed from the substrate.

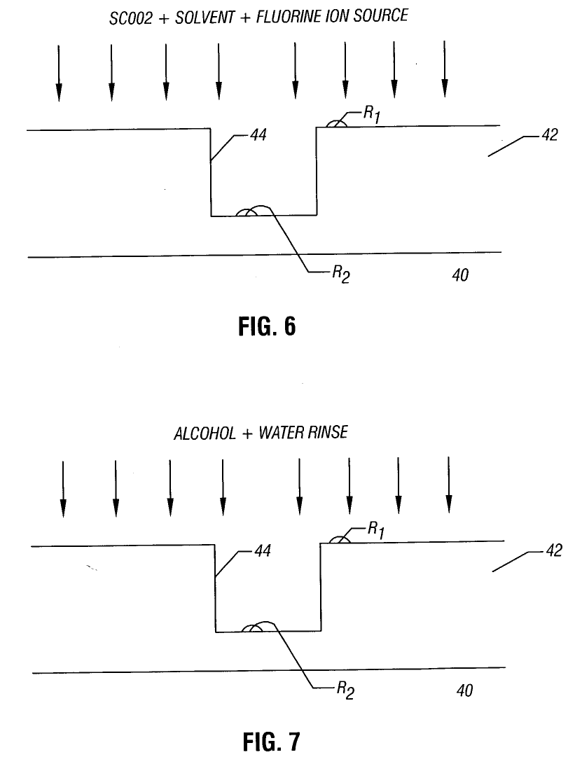

For example, referring to FIG. 6, in connection with a cleaning application, the residue R₁ and R₂ left on the top of an interlevel dielectric 42 (over a substrate) and on its sidewalls 44 may be removed using supercritical carbon dioxide, together with a solvent and a fluorine ion source.

A rinse step may use an alcohol-water mixture, with or without surfactants as indicated in FIG. 7. The cleaning is believed to occur through the dissolution of any antireflective coating by the fluorine ions. The rinse step is believed to remove the cleaning chemicals and reaction byproducts from the substrate.

The residue on the dielectric (for e.g. thin remaining film of ARC material at the ARC layer/ILD interface layer) exhibits different properties from that of the antireflective coating or bulk resist, as the case maybe, or interlevel dielectric materials. Moreover, any antireflective coating and the interlevel dielectric may have similar dissolution rates during the clean, increasing the difficulty of removing the residue completely without significantly attacking the interlevel dielectric.

Inadvertent etching of the interlevel dielectric may be reduced, by lowering the fluorine ion concentration or using a different or weaker chemistry in the second or any subsequent cleaning steps. As a result, the interlevel dielectric, and especially its sidewalls, may not be severely attacked. The ability to remove the residue selectively without unnecessary loss of the interlevel dielectric may be extremely advantageous in some embodiments.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming a two-phase mixture of supercritical carbon dioxide and liquid co-solvent; and
applying said two-phase mixture to remove unwanted material from a semiconductor substrate.

2. The method of claim 1 including forming droplets of liquid co-solvent suspended in supercritical carbon dioxide.

3. The method of claim 2 including removing dissolved material with the liquid co-solvent.

4. The method of claim 1 including using an amount of co-solvent that exceeds the solubility of said co-solvent in supercritical carbon dioxide.

5. A cleaning solution comprising:
supercritical carbon dioxide; and
a liquid co-solvent suspended in said carbon dioxide.

6. The solution of claim 5 wherein said co-solvent is in the form of liquid droplets.

7. The solution of claim 5 wherein the amount of liquid co-solvent exceeds its solubility in supercritical carbon dioxide.

8. A method comprising:
exposing a substrate, with material to be removed, to supercritical carbon dioxide and a solvent in a first concentration; and
re-exposing the substrate to supercritical carbon dioxide and the solvent in a second concentration.

9. The method of claim 8 including re-exposing using a second concentration that is the same as the first concentration.

10. The method of claim 8 including re-exposing using a second concentration that is different than said first concentration.

11. A method comprising:
exposing a substrate, with material to be removed, to supercritical carbon dioxide and a solvent in a first concentration;
rinsing the material to be removed with alcohol and water or organic solvents; and
exposing the rinsed material to be removed to supercritical carbon dioxide and a solvent in a second concentration that is same or different from said first concentration.

12. The method of claim 11 including providing a second rinse step and subsequent rinse steps using a different chemistry than said first or previous rinse steps.

13. The method of claim 11 including using a solvent in said first concentration with fluoride ions.

14. The method of claim 11 including cleaning contaminants from an interlevel dielectric by exposing said interlevel dielectric to supercritical carbon dioxide and a solvent at the first concentration and subsequently rinsing.

15. The method of claim 11 including re-exposing said dielectric to supercritical carbon dioxide and solvent with a reduced fluorine ion concentration.

16. The method of claim 11 including exposing the rinsed material to said second or subsequent concentration wherein said second concentration is less than said first or previous concentration.

17. A method comprising:
forming a mixture of supercritical carbon dioxide and suspended liquid co-solvent droplets; and
exposing material to be removed on a semiconductor substrate to said supercritical carbon dioxide with said suspended liquid droplets.

18. The method of claim 17 including using an amount of co-solvent that exceeds the solubility of said co-solvent in supercritical carbon dioxide.
